(19) United States
(12) Patent Application Publication
(10) Pub. No.: US 2026/0319446 A1
(43) Pub. Date: Oct. 15, 2026

(54) The Smart Internet of Things (IoT)- enabled Shower System with Advanced Safety Measures

(71) Applicant: Shadeeb Hossain, Brooklyn, NY (US)

(72) Inventor: Shadeeb Hossain, Brooklyn, NY (US)

(73) Assignee: Shadeeb Hossain, Brooklyn, NY (US)

(21) Appl. No.: 19/174,548

(22) Filed: Apr. 9, 2025

(51) Int. Cl. G05B 13/02; E03C 1/04; G08B 21/04; G16Y 10/80

(52) U.S. Cl. CPC G05B 13/027; G08B 21/043; E03C 1/041; G16Y 10/80

(57) ABSTRACT

The Smart IoT-Enabled Intelligent Shower System enhances safety in slippery shower environments by detecting distress signals using parallel acoustic sensors. A microcontroller processes signals and transmits data to an IoT platform, where spectrogram analysis and CNN-based image recognition validate emergencies and trigger automated responses. The system can shut off the shower nozzle upon distress detection and alert emergency contacts. A GUI allows users to monitor water and energy consumption in real time, while an integrated control system ensures water remains below 50 degrees Celsius to prevent scalding. User authentication enables personalized shower settings, and multiple sensors regulate water flow and temperature for optimal comfort.

### BACKGROUND OF THE INVENTION

This invention relates to shower space safety, water conservation, and consumer convenience. There have been significant instances of both non-fatal and fatal bathroom injuries, which are common among elderly individuals. This model performs multiple functions and is designed to address the concerns through a series of engineered processes.

Studies conducted by multiple regulatory bodies have identified shower space-related injuries as a growing concern, particularly in the absence of supervision. The primary hazards identified include slips, burns, and drowning. While these regulatory bodies often recommend consumer education on common hazards and prevention techniques, the implementation of advanced engineering technologies can significantly mitigate avoidable injuries.

Data from multiple case studies indicate that injuries frequently occur near the tub, shower space, or toilet. Accordingly, this invention focuses on developing a shower space capable of automatically detecting accidental falls or slips through the strategic placement of sensors and data analysis. The invention further aims to reduce the risk of scalding or burns by informing patrons of water temperature and monitoring shower duration.

The invention is also directed toward enhancing consumer convenience and comfort. A plurality of sensors is utilized to determine the optimal shower temperature based on consumer preferences, with interfaces designed to accommodate user inputs. The model further educates patrons on water and energy consumption through graphical user interfaces (GUI), including a waterproof monitor screen and accompanying sound notifications.

This model is characterized by the following features: (i) A sound-activated relay system configured to detect potential hazards, including instances of a patron falling within the shower space. (ii) A control mechanism for regulating shower duration and temperature to mitigate the risk of burns or scalding. (iii) A plurality of sensors strategically positioned to regulate and optimize water flow discharge, thereby enhancing consumer convenience.

### SUMMARY OF THE INVENTION

The smart Internet of Things (IoT)-enabled shower system integrates a network of sensor elements, including sound and ultrasonic sensors, interfaced with a microcontroller to detect accidental falls within the shower vicinity. Additionally, the system empowers users to customize their shower experience by selecting (i) water temperature, (ii) discharge flow rate, and (iii) monitoring key parameters such as (a) energy consumption and (b) occupancy duration. A secure, glass-protected display interface provides protection from water damage to the screen. To enhance safety, the system enforces a maximum temperature threshold of 49 degrees Celsius, effectively preventing scalding injuries.

The model detects sudden changes in frequency, typically within the kilohertz range, using sound sensors. When a significant acoustic event is detected, the microcontroller analyzes the sound spectrum and generates a spectrogram. Advanced algorithms, such as machine learning or spectral analysis techniques, are then applied to distinguish distress calls (e.g., ‘calling for help’) from background noise. This approach enhances reliability by ensuring that only meaningful acoustic events trigger an alert, reducing false positives from environmental sounds.

This methodology can be implemented alongside a strategically positioned array of ultrasonic sensors along the showerhead pole. The system activates water flow upon detecting the presence of a patron. However, if some ultrasonic sensors fail to register patron presence, this discrepancy serves as a secondary confirmation of a potential fall within the shower space.

The next step involves activating a relay switch to shut off the shower nozzle, preventing the patron from continued exposure to water. Additionally, the system can be designed to notify medical authorities or a designated guardian, whose contact information is stored in the database, ensuring timely assistance.

### BRIEF DESCRIPTION OF DRAWINGS

The features of the intelligent shower space and the structural and functional components of the embodiments are depicted in the accompanying drawings, wherein like reference numerals denote analogous elements, in which:

FIG. 1 is a perspective view of the intelligent shower space and its associated components in accordance with the invention.

FIG. 2 depicts a functional scenario in which a patron experiences a fall within the shower space, triggering the detection of a loud “thud” and/or a “call for help” by the components embodied in FIG. 1.

FIG. 3 illustrates a schematic representation of a patron's sound spectrum, wherein a spike in the frequency spectrum is detected because of the fall event.

FIG. 4 is a flowchart describing the operational sequences in the event of a fall detected by the elements in FIG. 1.

FIG. 5 presents a sequential flowchart outlining the proposed architecture for decision-making to differentiate between background noise and a “call for help.”

FIG. 6 illustrates an integrated circuit (IC) configuration for detecting high-frequency signals, such as a ‘loud thud’ or a ‘cry for help,’ wherein the detection is tuned to a specific frequency as determined by the equation provided in the accompanying drawing.

FIG. 7 presents a schematic representation of a proposed graphical user interface (GUI) designed to allow users to select their preferred shower water temperature and flow rate for optimal convenience.

FIG. 8 illustrates a flowchart depicting the sequential operations undertaken to affirm a potential fall within the shower vicinity through concurrent validation of sound signals and ultrasonic signals.

FIG. 9 illustrates a schematic representation delineating the sequence of operations executed to transmit automated notifications to designated medical authorities or guardians via mobile phone alerts or equivalent communication channels, upon validation of a potential fall incident within the shower vicinity.

### DETAILED DESCRIPTION OF THE INVENTION

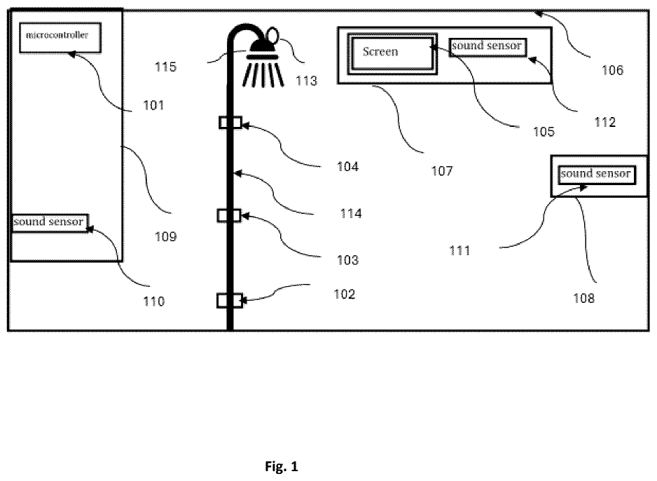

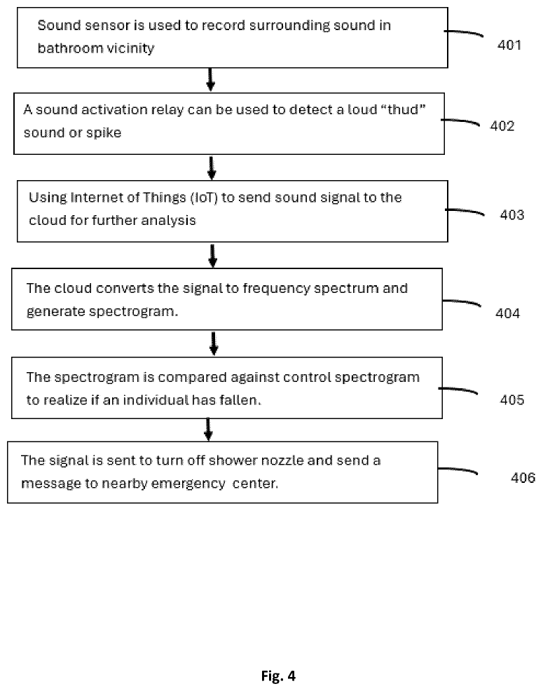

Referring to FIG. 1, the schematic architecture of an intelligent shower system is illustrated as an exemplary embodiment. The shower space (106) is equipped with multiple sound sensors (110, 111, and 112) strategically positioned at various corners of the vicinity. A monitor screen (105) is incorporated to display analytics related to water consumption, shower occupancy, and other relevant metrics. Additionally, multiple protective glass covers (107, 108, 109) are utilized to safeguard the sensor elements (110, 111, 112), the monitor screen (105), and the microcontroller (101). The microcontroller (101) connects the sound sensors (110, 111, 112) and the monitor screen (105) to the IoT platform. Multiple ultrasonic sensors (102, 103, and 104) are strategically positioned along the shower stand (114) to detect the presence of a patron within the vicinity. Additionally, a relay switch (113) is integrated into the shower head (115). The primary function of the relay switch (113) is to deactivate the shower head nozzle, as described in the sequence of steps depicted in FIG. 4.

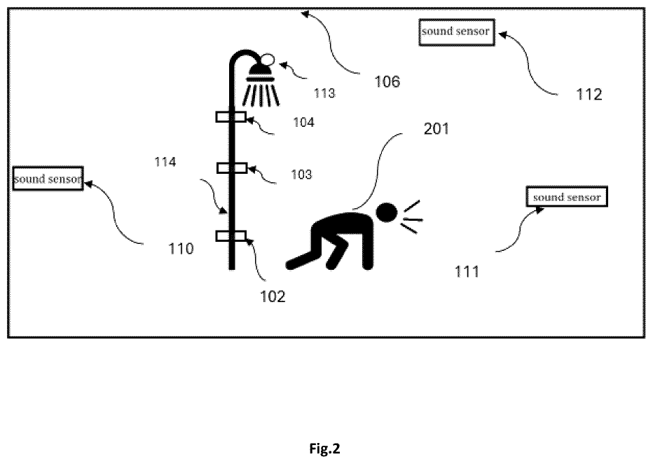

Referring to FIG. 2, a functional scenario of a triggered sound sensor due to changes in frequency detected in an embodiment of the intelligent shower space (106) is illustrated. In the event of a patron falling (201), the initial absence of a detected presence is noted by the ultrasonic sensors (104 and 103), but an obstacle is detected by sensor (102). If the patron has left the shower space (106), then all three ultrasonic sensors (102, 103, and 104) would not detect any obstacle within the 60-meter range.

The multitude of sound sensors (110, 111, and 112) also analyzes any sudden frequency spikes caused by a loud thud resulting from a fall or by the patron (201) calling for help. This triggers the relay (113) mounted on the shower stand (114) to turn off the water supply and initiate necessary steps to contact emergency services and/or notify the designated guardians.

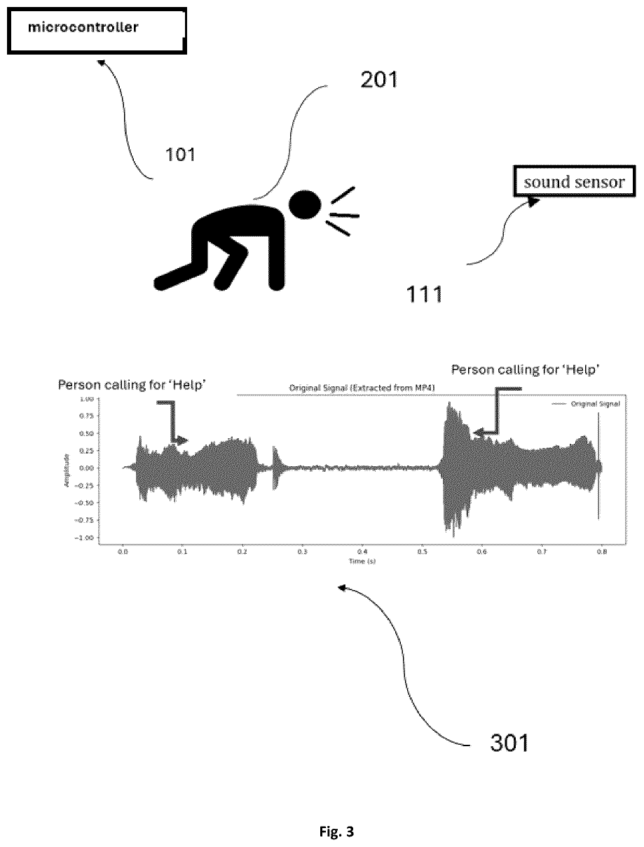

Referring to FIG. 3, a schematic representation of the patron's sound spectrum (301) as detected by the sound sensor (111) and analyzed by the microcontroller (101) is illustrated. In a preferred embodiment, a plurality of sound sensors (111, 112, and 113), as shown in FIG. 1, simultaneously detects changes in sound frequencies in the background. An algorithm, such as Fourier Transform, may be utilized to perform frequency analysis. The details of the analysis and the proposed architecture of the algorithm are further elaborated in FIG. 3.

Referring to FIG. 4, a flowchart illustrates the mode of operation of the smart shower space according to this invention. Sound sensors (110, 111, and 112) are configured to record fluctuations in the sound spectrum when a patron (201) enters the vicinity (106) at step 401. Upon detecting a loud “thud” or a similar occurrence, the plurality of sound sensors (110, 111, and 112) transmit the corresponding sound signal data (301) to the cloud via the microcontroller (101) for additional analysis and confirmation at step 402 and 403.

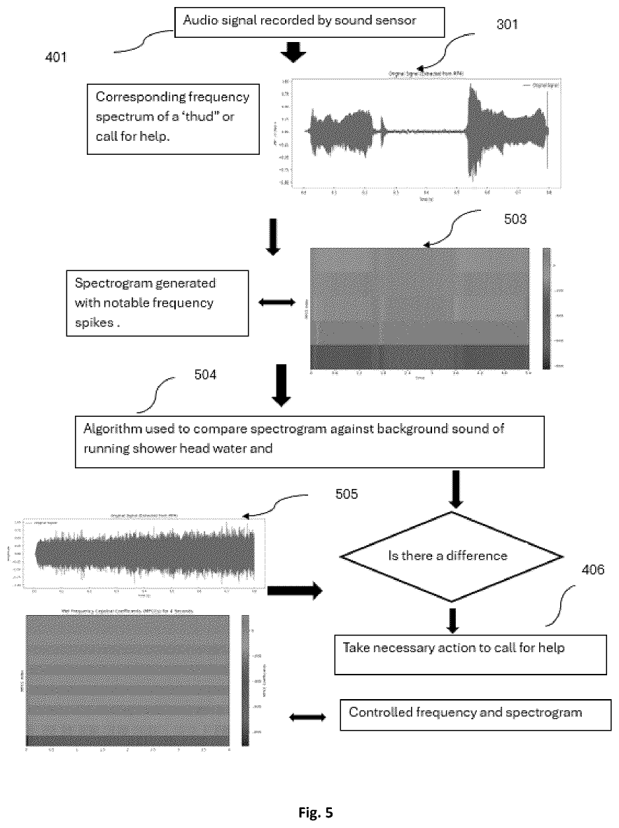

An algorithm is implemented to translate the transmitted sound signal into an equivalent spectrogram (503) at step 404. The details of this analysis are further discussed in FIG. 5. If the algorithm confirms that the patron (201) has fallen within the shower space (106) as outlined in step 405, subsequent steps are executed, including turning off the shower head (115) using a relay switch (113). Additionally, a notification is sent to a registered emergency center as outlined in step 406.

Referring to FIG. 5, the illustrated sequence of steps constitutes a framework for analyzing the decision-making architecture used to distinguish between background noise and a “call for help.” While this methodology represents a preferred embodiment, alternative approaches and modifications to individual steps may be employed to achieve the core objective.

In step 401, audio signals are continuously monitored and recorded by sound sensors 110, 111, and 112. The corresponding frequency spectrum, exemplified as a sample (301), is depicted in FIG. 5. Advanced algorithms executed on an Internet of Things (IoT) cloud platform generate an equivalent spectrogram, as shown in 503.

For comparative analysis, a pre-existing frequency spectrum and its corresponding spectrogram (505) may serve as a control dataset. The decision-making framework incorporates convolutional neural network (CNN) architectures to perform spectrogram image comparisons, employing binary classification methodologies to accurately categorize real-time audio signals. Upon detecting significant anomalies indicative of a potential emergency, the system initiates a notification to registered emergency services, as described in step 406.

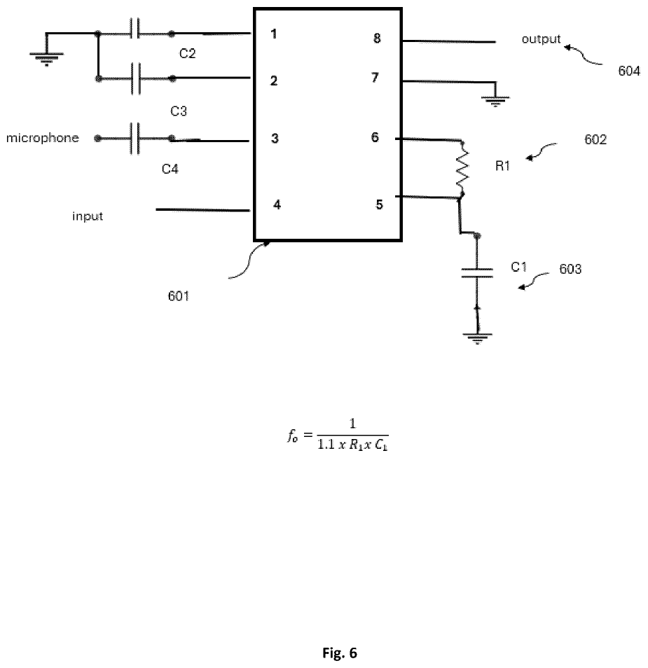

Referring to FIG. 6, an integrated circuit (IC) 601, such as an LMS 67 IC decoder, may be utilized to detect high-frequency signals in the kilohertz (kHz) range, including a ‘thud,’ an ‘accidental fall,’ or a ‘high-frequency cry for help.’ The IC circuit configuration incorporates a combination of resistors (602) and capacitors (603) to define a specific frequency response, wherein the values of these circuit components may be adjusted to fine-tune the bandwidth. The output signal (604) from the IC may be coupled to a relay switch (113), which, upon activation, can interrupt the water supply to the showerhead (115).

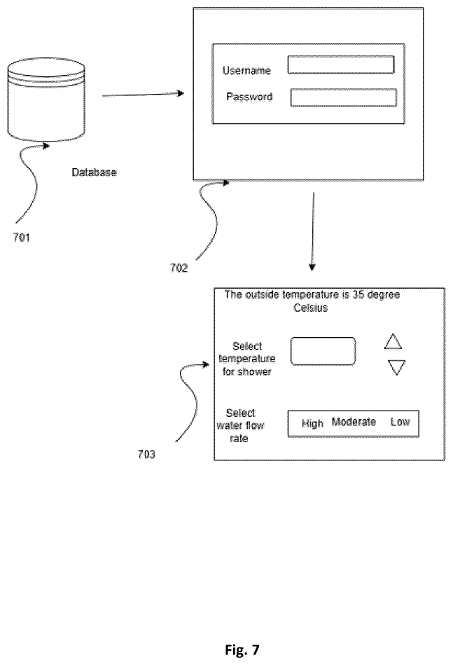

Referring to FIG. 7, a graphical user interface (GUI) (702) is displayed on the monitor screen (105), which is protected by a glass screen (107) as illustrated in FIG. 1. The system securely stores login credentials and relevant user data in a cloud-based database (701), ensuring authentication and data privacy.

Through the GUI, the user can select a preferred shower temperature and adjust the corresponding water flow rate (703). To enhance safety and prevent scalding, the system imposes a maximum temperature threshold of 49-degree Celsius. If a user attempts to set a temperature exceeding this limit, the system automatically regulates it to ensure safe operation. The temperature regulation mechanism is designed based on established health and safety guidelines for water exposure, minimizing the risk of burns while maintaining user comfort.

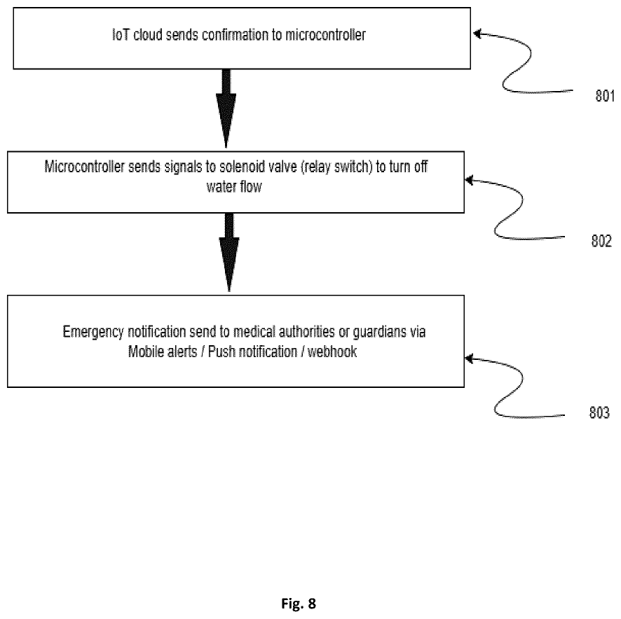

Referring to FIG. 8, a simplified flowchart is illustrated, delineating the sequential framework of actions undertaken following the confirmation (801) of an accidental fall within the shower vicinity (106). The procedural framework comprises two primary actions: (i) actuating the solenoid valve (113) to automatically discontinue the water flow from the shower nozzle (115) (802), and (ii) transmitting emergency notifications to designated medical authorities or guardians via mobile alerts, push notifications, or webhooks (803).

Upon confirmation (801) of a fall, a microcontroller (101) generates an actuation signal to the solenoid valve or relay switch (113) affixed to the shower head (115). This action (802) is intended to prevent the fallen patron (201) from prolonged water exposure or inflicting further discomfort upon individuals arriving for rescue assistance. The microcontroller (101) may also trigger the solenoid valve (113) closure contingent upon a parallel multi-sensor confirmation. Specifically, such confirmation may occur if the ultrasonic sensor (102) detects an obstruction in the shower vicinity (106) while the adjacent sensors (103, 104) fail to detect any corresponding obstruction.

To further mitigate the likelihood of false-positive alerts, the microcontroller (101) is programmed to execute a secondary validation by analyzing the spectrogram (405) for high-frequency distress signals. Upon concurrent positive confirmation from both the spectrogram analysis (405) and the multi-sensor response, the microcontroller (101) activates the solenoid valves (113) to halt water flow and simultaneously trigger emergency notifications to medical authorities or guardians. This parallel confirmation mechanism serves to minimize erroneous activations, thereby enhancing the reliability of the fall detection system.

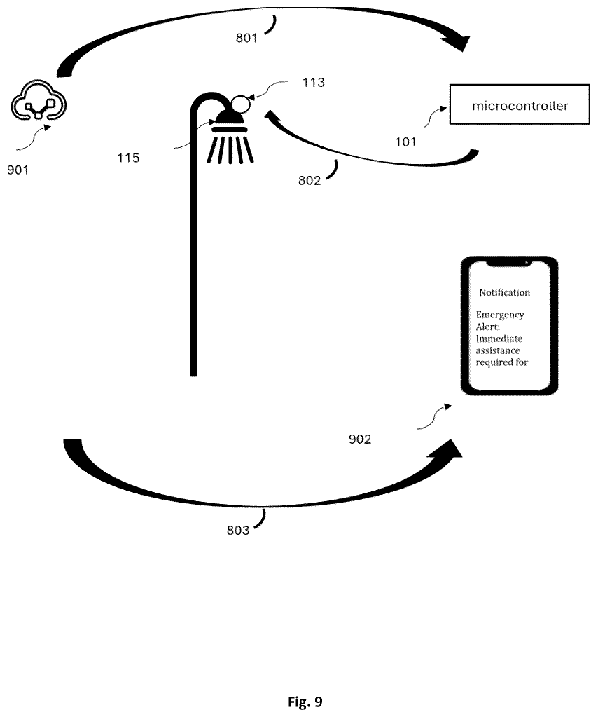

Referring to FIG. 9, the schematic architecture illustrates the concurrent sequence of actions as outlined in FIG. 8 (801, 802, and 803), initiated upon validation of a potential fall incident through spectral analysis of sound signals (301, 503) processed via the IoT cloud network (901). The operational function of the solenoid valve (113) has been previously discussed; however, the parallel course of action encompasses the transmission of notifications to designated medical authorities (803) or registered guardians, utilizing information stored in the database (701).

For mobile application-based notifications, Firebase Cloud Messaging (FCM) can be employed to trigger a push notification to the recipient's mobile device (902). Alternatively, another viable approach involves establishing a communication link between the IoT cloud network (901) and third-party webhook APIs. Upon confirmation of a fall incident (801), the IoT cloud network (901) invokes the webhook URL, thereby facilitating the immediate dispatch of push notifications to the mobile device (902).

We claim:

1. A smart Internet of Things (IoT)-enabled intelligent shower system, comprising:
A plurality of high-frequency sound sensors positioned within an active shower area, configured to detect frequency signals within a predefined range.
A microcontroller operably connected to the sound sensors, configured to receive detected signals and transmit data to an IoT cloud system for real-time analytics.
A signal-processing algorithm designed to convert frequency signals into a spectrogram and perform image analysis using a convolutional neural network (CNN).
An integrated circuit (IC) configuration designed to detect a specific bandwidth of signals indicative of a potential fall within the shower vicinity, wherein upon detection, the system is configured to trigger an assistance alert and initiate closure of the shower valve.
A graphical user interface (GUI) equipped with secure authentication credentials, interfacing with a database.
A relay system comprising an electric solenoid actuator configured to automatically shut off the shower valve upon confirmation of a patron's fall within a predefined perimeter of the shower vicinity.
A notification system configured to transmit push notifications and alert designated guardians or authorized medical personnel upon detection of a patron's fall within the shower vicinity.

2. The system of claim 1, further comprising a display screen configured to present water consumption analytics in real time.

3. The system of claim 1, further comprising a protective glass enclosure designed to shield electronic components from water exposure.

4. The system of claim 1, further comprising a plurality of ultrasonic sensors strategically positioned within the shower vicinity, configured to detect the presence of a patron and assist in identifying potential accidental falls.

5. The system of claim 4, wherein activation by all or most of the ultrasonic sensors generates a signal to the microcontroller to trigger the activation of the shower nozzle, initiating water flow.

6. The system of claim 4, wherein activation of ultrasonic sensors positioned at the lower portion of the shower stand, without a corresponding signal from previously activated ultrasonic sensors at the upper portion, generates and transmits a discrepancy signal to the microcontroller.

7. The system of claim 1, further comprising a sound processing unit configured to analyze variations in frequency within the shower vicinity.

8. The system of claim 7, wherein frequency variations are processed to generate a real-time spectrogram using an algorithm.

9. The system of claim 8, wherein the spectrogram is analyzed using a machine learning algorithm that compares it to a reference spectrogram to assess the likelihood that the detected sound spectrum corresponds to a fall.

10. The system of claim 1, wherein upon confirmation of a fall within the shower space, the system transmits an SOS message or alert notification to registered healthcare providers or designated guardians.

11. The system of claim 1, further comprising:
A touchscreen monitor for secure user authentication.
A selection interface for water flow rate and temperature settings.
A system algorithm programmed to mitigate the risk of scalding by enforcing a maximum water temperature threshold of 49° C.

12. The system of claim 1, further comprising:
An electric solenoid actuator configured to receive a control signal from a microcontroller and, in response, automatically shut off the shower nozzle valve.
A mechanism for actuating the shower nozzle shutoff using either a 12V DC electric solenoid valve or a 110V AC solenoid valve.

13. The system of claim 1, further comprising:
A push notification system integrated with an IoT device for transmitting real-time alerts.
A microcontroller configured to verify a fall using CNN image analysis or multi-sensor analysis.
A notification transmission mechanism using Firebase Cloud Messaging (FCM) or webhook APIs to deliver alerts to a designated mobile device.
